(19) United States
(12) Patent Application Publication
(10) Pub. No.: US 2019/0031154 A1
(43) Pub. Date: Jan. 31, 2019

(54) SELF-REGULATING HEATING DEVICE FOR THE LIQUID OF A VEHICLE WINDOW WIPER SYSTEM

(71) Applicant: Valeo Systèmes d'Essuyage, Le Mesnil Saint Denis (FR)

(72) Inventors: Geoffrey Bayard, Issoire (FR); Nadia Berthon, Issoire (FR)

(73) Assignee: Valeo Systèmes d'Essuyage, Le Mesnil Saint Denis (FR)

(21) Appl. No.: 16/072,044

(22) PCT Filed: Jan. 20, 2017
(86) PCT No.: PCT/EP2017/051201

§ 371 Date: Jul. 23, 2018

(30) Foreign Application Priority Data
Jan. 28, 2016 (FR) 1650686

(51) Int. Cl. B60S 1/48; H05B 3/44; F16L 53/38

(52) U.S. Cl. CPC B60S 1/488; H05B 3/44; H05B 2203/02; H05B 2203/014; F16L 53/38

(57) ABSTRACT

The invention concerns a device (15) for conveying and heating a liquid, intended to be installed between a means for circulating the liquid and a wiper blade of a wiper system, comprising a wall (21) delimiting at least one conduit (22, 23) for circulating the liquid and an electrical circuit intended to connect two terminals set to different potentials and comprising a heating element embedded in said wall (21), characterised in that at least one portion of said electrical circuit is formed by a self-regulating cable (30) arranged to limit a current flowing through the electrical circuit depending on an increase in temperature. Said invention can be used for motor vehicles.

The technical sector of the present invention is that of the systems for supplying and/or dispensing windscreen washer liquid for motor vehicles. Such a system complements an installation for wiping the front and/or rear windows of the vehicle. More particularly, the invention targets a device for transporting and heating liquid between a tank and a spraying system.

Motor vehicles are commonly equipped with a wiping installation and a washing system to ensure a wiping and a washing of the windscreen, and thus avoid having vision that the driver has of its environment being disrupted. These wiping installations comprise arms performing an angular reciprocating movement, at the end of which elongate brushes are installed, themselves bearing wipers produced in an elastic material. These blades rub against the windscreen and dispel the water by bringing it out of field of vision of the driver.

The washing systems comprise, for their part, a device for bringing a windscreen washer liquid which is routed from a tank situated on the vehicle and which is sprayed towards the windscreen by spray nozzles generally situated on the hood, on the windscreen bay grating or on the windscreen wiper itself for a better dispensing of the liquid. In the case of nozzles placed on the wipers, the windscreen washer liquid is routed, before being distributed between them, by pipelines which are fixed onto the wiper arm.

When the outside temperature is too low, for example below 5° C., the windscreen washer liquid is heated to defrost or keep it liquid. For that, the pipelines are equipped with a device for reheating the windscreen washer liquid which has been taken from the tank by a pump, at the moment when the control of the windscreen washer is actuated.

The heating of the liquid in the transport duct is ensured by a heating element which runs next to or inside the duct. This arrangement has the major drawback that the temperature dissipated by the heating element results from a heating which always dissipates the same energy, whatever the ambient temperature. The temperature reached in the liquid ducts can then rise abnormally and reach values which constitute a problem with respect to the immunity of the materials of said duct, in particular rubber or plastic, or to the vaporization of the windscreen washer liquid. In the most severe cases, such as, for example, operation when idling for thirty minutes with an outside temperature of +5° C., the temperature of the liquid in the heating pipes can reach 160° C. It will therefore be understood that such a temperature is problematic for the water contained in the pipes and for the flexibility and watertightness of the rubber.

The aim of the present invention is therefore to resolve the drawbacks described above, primarily by providing a heating device for a system for supplying and/or dispensing windscreen washer liquid of a vehicle, which operates in closed loop mode, that is to say which is capable of simply and inexpensively regulating the temperature reached by the liquid, whatever the conditions of use of the vehicle. The heating device must, among other things, be sufficiently miniaturized to be incorporated in a windscreen wiper arm and remain sufficiently flexible for it to be able to accept pulling or flexing deformations which are due to the movements of this windscreen wiper arm.

The subject of the invention is thus a device for transporting and heating a liquid intended to be installed between a liquid circulating means and a wiper of a wiping system, comprising a wall delimiting at least one liquid circulation duct and an electrical circuit intended to link two terminals set at different potentials and comprising a heating element embedded in said wall, characterized in that at least one portion of said electrical circuit is formed by a self-regulating cable arranged to limit a current running in the electrical circuit as a function of a temperature rise.

The presence of the self-regulating cable in the electrical circuit, acting as a thermostat, makes it possible to operate in closed loop mode and to limit the temperature rise in the transport and heating device to a predefined value. There is thus no longer a risk of vaporization of the windscreen washer liquid or of degradation of the material of which the device is composed.

Preferentially, said self-regulating cable comprises at least two electrically conductive heating wires, brought to different electrical potentials. Said wires are, for example, linked to one another by a semiconductive matrix.

Advantageously, at least one of said conductive wires comprises at least one conductive strand helically wound around an insulating fibre. This configuration gives flexibility to the self-regulating cable and allows it to withstand the pulling and flexing forces imposed by the reciprocating movement of the wiper arms.

Advantageously, the conductive wire comprises at least three juxtaposed strands, helically wound around said insulating fibre.

Preferentially, the pitch of the helix lies between 1 and 10 turns over a length of 5 cm. These values make it possible, by the effect that they have on the resistivity of the self-regulating cable, to obtain temperatures which remain below admissible limit values.

In a first embodiment, the self-regulating cable constitutes the heating element and is formed by two heating wires and a semiconductive matrix. The two wires advantageously extend parallel to said duct and/or equidistant therefrom. By this configuration, the semiconductive matrix, which forms the heating element, extends along the duct or ducts in which the liquid circulates.

Advantageously, the above device comprises two cylindrical liquid circulation ducts, symmetrical to one another relative to a plane, in which the self-regulating cable is positioned in said plane. Said semiconductive matrix extends, in cross section, for example, on either side of the line linking the centres of gravity of the sections of the two ducts. The cable is thus placed in such a way as to radiate its heat throughout the section of the ducts.

In a second embodiment, the self-regulating cable constitutes the heating element and is formed by two heating wires and a semiconductive matrix, the two wires being concentric and the matrix being positioned in the interval situated between the two wires.

Preferentially, the inner heating wire comprises the conductive strand helically wound around the insulating fibre, described above.

More preferentially, the outer heating wire comprises at least one conductive strand helically wound around said semiconductive matrix.

Advantageously, the device comprises two liquid circulation ducts, symmetrical to one another relative to a plane, in which the self-regulating cable is positioned on the line linking the centres of gravity of the sections of the two ducts. The cable is, here again, placed in such a way as to radiate its heat throughout the section of the ducts.

In a third embodiment, the self-regulating cable constitutes the heating element and is formed by two heating wires coated in a semiconductive matrix and each comprising a conductive strand helically wound around an insulating fibre, the two wires being twisted with one another.

Here again, the device advantageously comprises two cylindrical liquid circulation ducts, symmetrical to one another relative to a plane, in which the self-regulating cable is positioned on the line linking the centres of gravity of the sections of the two ducts. In a fourth embodiment, the device comprises at least one self-regulating cable of which a first of said at least two conductive wires is linked to a terminal of said electrical circuit and a second of said at least two conductive wires is linked to an end of said heating element.

Here, the self-regulating cable acts only as thermostat and does not have to fulfil the heating function. Advantageously placed in a zone representative of maximum temperatures that can be reached, it should be dimensioned only for the thermostat function and can therefore be less bulky and less costly.

Advantageously, at least a part of the self-regulating cable is also embedded in said wall, downstream of the heating element relative to the circulation of the liquid.

That makes it possible to set the voltage breaking performed by the self-regulating cable by being based directly on the temperature of the liquid, for example to break at 100° C. and avoid the occurrence of steam pockets.

The invention relates also to a pipeline for transporting windscreen washer liquid comprising a transport and heating device as described above.

The invention relates also to a system for supplying and/or dispensing windscreen washer liquid to be sprayed onto a window of a vehicle comprising at least one tank, a liquid circulating means, a means for spraying said liquid and such a pipeline for transporting windscreen washer liquid.

Other features, details and advantages of the invention will emerge more clearly on reading the description given below by way of indication in relation to the drawings in which:

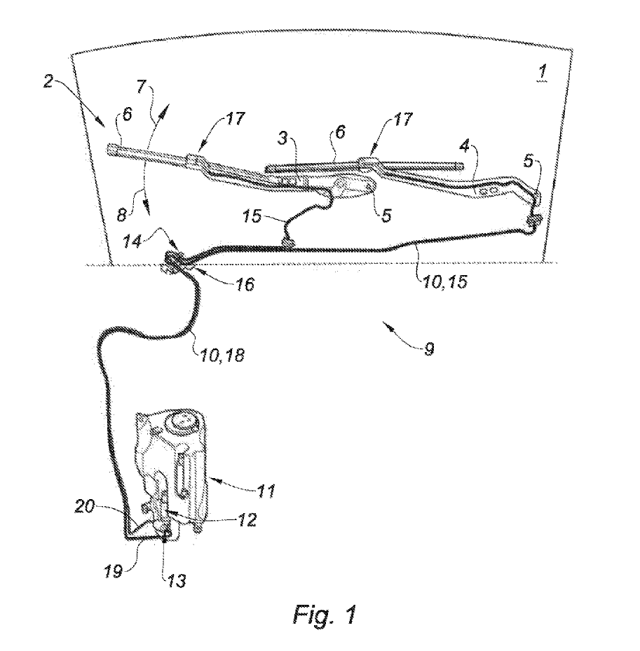

FIG. 1 is a general view of a wiping installation and of a system for supplying and/or dispensing windscreen washer liquid, comprising at least one liquid transport and heating device according to the invention,

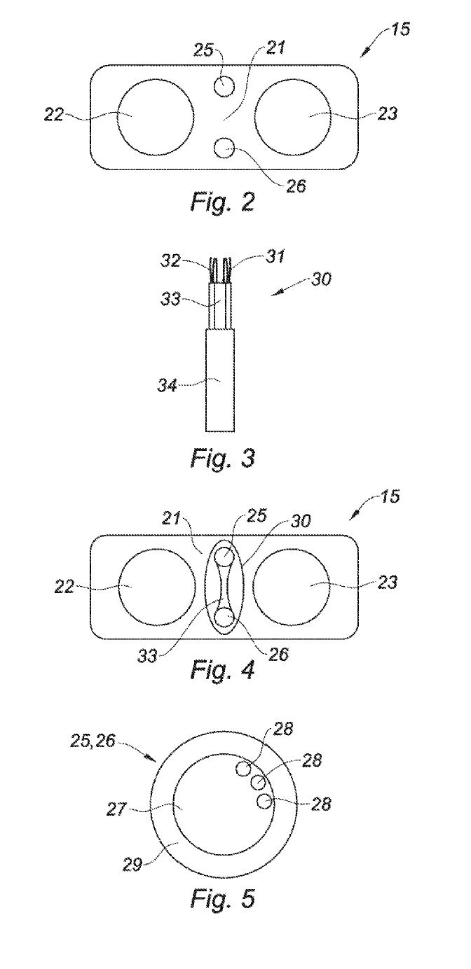

FIG. 2 is a cross-sectional view of a transport and heating device, according to the prior art, implanted in the rubber of a windscreen washer liquid transport pipeline,

FIG. 3 is a front view of a self-regulating cable,

FIG. 4 is a cross-sectional view of a transport and heating device, according to a first embodiment of the invention, implanted in the rubber of a windscreen washer liquid transport pipeline,

FIG. 5 is a cross-sectional view of a heating wire of a self-regulating cable according to the invention,

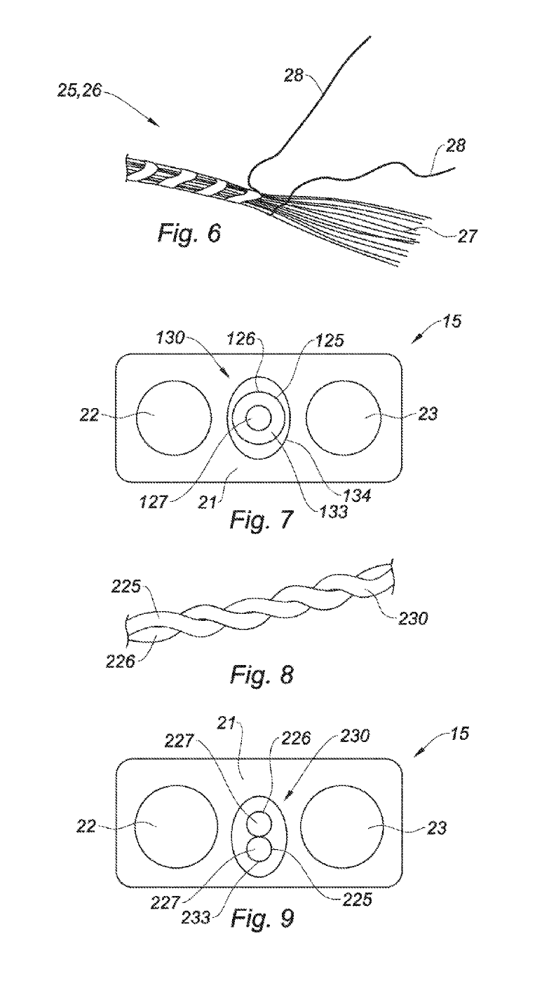

FIG. 6 is a perspective view of the wire of FIG. 4,

FIG. 7 is a cross-sectional view of a transport and heating device, according to a second embodiment of the invention, implanted in the rubber of a windscreen washer liquid transport pipeline,

FIG. 8 is a front view of a self-regulating cable for a third embodiment of the invention,

FIG. 9 is a cross-sectional view of a transport and heating device, according to the third embodiment of the invention, implanted in the rubber of a windscreen washer liquid transport pipeline,

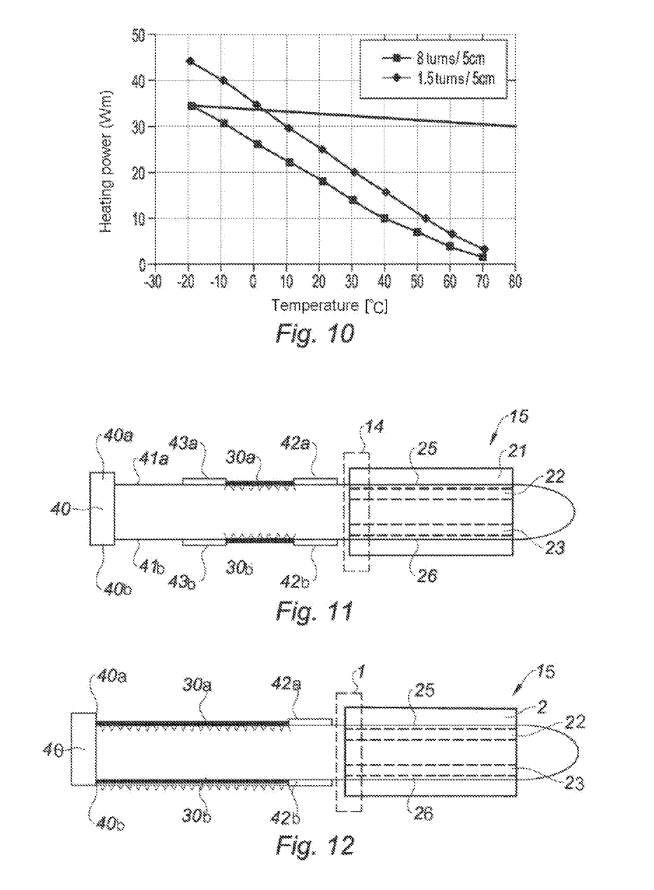

FIG. 10 is a diagram representing the trend of the heating power supplied by a device according to the invention, as a function of its temperature,

FIG. 11 is a schematic view of a transport and heating device, according to a fourth embodiment of the invention, and

FIG. 12 is a schematic view of a transport and heating device, according to a variant of the fourth embodiment of the invention.

FIG. 1 is a view illustrating a windscreen 1 of a motor vehicle intended to be wiped by a wiping installation 2. The latter comprises a first arm 3 and a second arm 4, each of them being linked, for example, to an axis of rotation 5. These two arms move over the windscreen 1 according to a combined or opposing reciprocating movement.

At the end opposite the axis 5 relative to the first arm 3 and to the second arm 4, there is a wiper 6 whose function is to scrape the windscreen to push back the water or the other bodies present thereon into zones of the windscreen which do not hamper visibility. These wipers 6 are linked to each arm by a removable connector allowing a replacement of the wiper when the latter is worn.

The wipers each comprise, for example, two distributers for spraying a windscreen washer liquid. These distributers extend longitudinally in a same axis as the longitudinal axis of the wiper 6. These distributers are arranged on either side of the wiper, so as to spray the windscreen washer liquid in front of the blade whether the latter is moving in a first direction of movement illustrated by the arrow 7 or in a second direction of movement illustrated by the arrow 8.

As illustrated in FIG. 1, the invention relates to a system for supplying and/or dispensing 9 windscreen washer liquid with which the vehicle is equipped. For the distributers to spray this liquid, it is necessary to have a windscreen washer liquid storage device, a means for transporting this liquid between the storage device and the distributers, and a means for circulating this liquid towards the distributers.

This supply and/or dispensing system 9 comprises, in particular:

a liquid retention tank 11,

a means for circulating 12 the liquid in the supply and/or dispensing system, a pump in particular,

at least one hydraulic coupling 13 intended to link the pump to a liquid transport and heating device 10,

a liquid transport pipeline 10 comprising a first part 18 which is linked to the pump and a second part 15 which is linked to each of the wipers 6,

a coupling device 14 installed on said first part 18 and said second part 15 of the transport pipeline,

a support 16 capable of mechanically grouping together the coupling device 14 and one or more electrical connectors which power the heating elements embedded in the liquid pipeline 10 mentioned above and the heating elements incorporated in the wiper,

a hydraulic connector 17 installed between the liquid transport pipeline 10 and the connector of the wiper 6.

The invention relates also to a device for transporting and heating liquid. It is more particularly in the second part 15 of the pipeline 10 that it is designed to be implanted, although it is also possible for it to be implanted in the first part 18 of said pipeline 10, together with said second part, or not.

In the example of FIG. 1, the first part 18 of the liquid transport and heating pipeline comprises two pipes 19 and 20 in which the liquid can circulate, each pipe corresponding to the supply to one of the two distributers borne by the wiper or wipers. These pipes are split into two at the coupling device 14 to separately supply each of the liquid transport and heating devices, in accordance with the invention, and ultimately the two windscreen wipers. The liquid transport and heating devices are, for example, each produced in the form of a flexible tube which comprises two internal liquid circulation ducts 22 and 23, as can be seen in FIG. 2, each internal duct corresponding to the supply of windscreen washer liquid for a particular direction of movement of the wiper. The material forming such a tube can, for example, be an elastomer or a rubber.

This liquid transport and heating device 10 also comprises a heating element (not visible in FIG. 1) which runs along the pipes and tubes, by being embedded in the constituent material thereof. Such a heating element is a resistive element, which, in the prior art, takes the form of a first and a second electrically conductive wires, which, when they are passed through by an electrical current, give off calories. It will therefore be understood that this heating element forms a source of heat from which the liquid transport and heating device draws energy and dissipates all around the space in which the liquid is or circulates.

FIG. 2 shows the detail of the implanting, according to the prior art, of a heating device inside the liquid transport and heating device. Each tube 15 comprises a median wall 21 which separates the first duct 22 from the second duct 23.

The heating element comprises the first electrically conductive wire 25 which runs parallel to the second electrically conductive wire 26. These two wires are linked to one another at their distal end, that is to say at the wiper level, so as to form, in the prior art represented here, a go and return cable in the form of a loop for the electrical heating current. They are, for example, two wires made of copper or of an aluminium alloy which are separated from one another and dimensioned to give off calories when they are passed through by a current of a voltage of between 9 and 16 volts and of an intensity lying between 1.5 and 10 amperes. These two wires are embedded in the wall 21 and can, advantageously, be covered with a sheath dedicated to each wire. Embedded should be understood, for example, to mean the fact that the constituent material of the wall 21 completely surrounds the heating element.

Now referring to FIG. 3, a self-regulating cable 30 can be seen. This cable is composed of two conductive wires 31 and 32, composed of a series of braided strands, which extend parallel to one another and between which a predefined voltage difference is applied, the two conductors not being linked in a loop at their distal end. Between them, a carbon-enriched polymer matrix 33 extends, constituting the heating element. The cable assembly is finally placed in a protective sheath 34, which is electrically insulating but which is not thermally insulating. The current ensuring the heating runs from one conductor to the other through said matrix which, being carbon-enriched, operates as a semiconductor, that is to say that its resistivity increases as its temperature increases, by virtue of the expansion of its internal structures. Also, this expansion leads to a reduced space available for the running of the current.

Consequently, when its temperature rises, the power dissipated by the cable decreases, which ensures self-regulation of the dissipated power. In operation, the cable will therefore always reach a balance between the power that it dissipates and the losses due to the external environment. That normally avoids any overheating which could degrade the cable or the surrounding material. Furthermore, the resistivity of the matrix is variable along the cable with its temperature, which allows for a part of the cable which is placed over its length in a colder environment to transmit more energy in this zone. There is therefore a self-adaptation of the temperature of the cable for all its parts whatever the thermal environment in which they are located.

The invention proposes using such a cable to ensure the heating of the liquid sent to the windscreen wipers, by miniaturizing it and by conforming it in such a way that it accepts the stresses, both pulling and flexing, which are generated by the to and fro movements of the transport device on the windscreen.

FIG. 4 shows, according to a first embodiment of the invention, a heating cable 30 embedded in the wall 21 of the windscreen washer liquid transport and heating device. The self-regulating heating cable 30 is composed of the two heating wires 25 and 26 and of a semiconductive matrix 33 which links them electrically, the self-regulating cable being also protected by an insulating sheath. The heating cable 30 has, in cross section, an elongate form, the large dimension of which is oriented in the direction of the wall 21. This means that the heating generated by the self-regulating cable radiates over all the height of the wall which is situated between the first and second liquid circulation ducts 22 and 23. It thus ensures a much better heating of the liquid than in the prior art of FIG. 2, where the heat was radiated from two points close to the ends of said wall 21.

Advantageously, the heating wires 25 and 26 of the self-regulating heating cable each have an end linked to a terminal of an electrical circuit intended to be connected to an electrical connector, not represented, so as to create a voltage difference between the heating wires 25, 26 by an electrical source embedded on the vehicle, also not represented. Conventional conductive cables, also not represented, can link the connector to the heating wires according to the relative positions of these elements on the vehicle.

Referring now to FIGS. 5 and 6, these show the structure adopted by the invention for the form of the heating wires 25 and 26, and which allows them to withstand pulling and flexing stresses. Each wire consists of a cylindrical core produced as insulating fibre 27 on which metal strands 28 are spirally wound. These strands, of which there are three, without this number being essential, are attached to one another and they form a helix along the insulating fibre 27. The pitch of this helix is variable as a function of the self-regulation performance desired for the temperature of the windscreen washer liquid heating cable 30 as will be explained later referring to FIG. 10. An increase in the pitch in fact results in a lowering of the heating power given the same temperature. An electrically insulating sheath 29 here jackets the central fibre 27 and the helical strands 28 to protect the duly constituted heating wire, against external attacks. The helix structure gives the self-regulating cable 30 a significant longitudinal flexibility, whereas braided structures would exhibit a longitudinal rigidity less well suited to an application in a windscreen washer liquid transport and heating device.

FIG. 7 shows a second embodiment of a transport and heating device 15 according to the invention. The latter comprises, as in the preceding case, a self-regulating cable 130 positioned in the median wall 21 of a windscreen washer liquid supply tube. This cable is composed of two heating wires 125 and 126 which are positioned concentrically. They are both formed by metal strands which are helically mounted around a support fibre. The strands of the inner wire 125 are wound on an insulating central fibre 127, in a configuration similar to that of FIG. 5, whereas the strands of the outer wire 126 are helically wound on a cylinder composed, for example, of a semiconductive matrix 133 similar to that 33 of the first embodiment, but in a cylindrical form. The assembly is enclosed in an electrically insulating sheath 134, before being embedded in the median wall of the tube 15.

Finally, FIGS. 8 and 9 show a third embodiment. The two heating wires 225 and 226 are both produced according to the structure illustrated in FIG. 5, that is to say that they are formed by metal strands, each wound helically on an insulating fibre 227 then embedded in a sheath 233 made of semiconductive material. They are then wound one on top of the other so as to form a twisted cable 230.

FIG. 10 shows, in a diagram, for a given potential difference between the conductive wires, the heating power which is delivered by a heating cable 30, 130, 230 as a function of its temperature. The thick line curve shows the power dissipation in the prior art, with a power which remains substantially constant because of almost invariable resistivity of the conductive wires. Because of this, the temperature of the heating cable increases regularly during the heating phase, with the risks indicated previously concerning the vaporization of the windscreen washer liquid and the loss of the elastic qualities of the rubber.

By contrast, in the invention, the heating power emitted by the semiconductive matrix 33 does not increase during the heating phase. It is, for example, constant with certain alloys or decreases regularly during the heating phase.
The curve with the squares positioned diagonally gives the trend of the power in the case of strands 28 helically wound on the insulating fibre 27 with a pitch of 1.5 turns per 5 cm of elongation, while the curve with the squares positioned upright gives the trend of this power in the case of a helix with 8 turns over 5 cm. It can be seen that, for these two helix pitch values, the power delivered is practically cancelled out when the temperature of the cable reaches 70° . The invention thus makes it possible to limit the temperature of the cable to 70 or 75° C. and therefore to neither vaporize the windscreen washer liquid nor degrade the quality of the elastomer which is used to form the tubes transporting this liquid. This limiting of the temperature is performed entirely independently, without the need to incorporate a device for regulating the voltage which would be applied to the conductive wires to limit the temperature of the cable in extreme conditions of use of the vehicle.

Ultimately, the invention is characterized by the use of cables advantageously formed by a semiconductive matrix which is placed between two heating wires, and which are embedded in the median wall of the transport and heating device 10. Also, to obtain a resistance of this self-regulating cable 30, 130, 230 to pulling forces in its longitudinal direction or flexing forces on an axis at right angles to this longitudinal direction, the heating wires are preferentially produced in the form of metal strands 28 helically wound around a fibre 27. The helical form of the metal strands gives the freedom of deformation sought for the cable and also makes it possible, through a modulation of the pitch of the helix, to adjust the value of the limit temperature that this cable reaches as a function of the heating power supplied. In any case, the temperature of the cable reaches a limit value when the heating power increases, through the effect of self-regulation of the temperature of the cable.

Also, a fourth embodiment uses this effect of self-regulation of the electrical power running through the self-regulating cable by its temperature to limit the heating by a conventional heating element.

FIG. 11 illustrates one such embodiment. In this example, each tube 15 comprises, according to the prior art described previously with regard to FIG. 2, a heating element formed by two heating wires 25, 26 embedded in the wall 21 of the tube 15 and linked at their distal end. The free end of each heating wire exits from the tube, for example at the coupling device 14 of supply and/or distribution system 9 as was described in relation to FIG. 1.

So as to activate the heating element 25, 26, the latter is included in an electrical circuit which forms a loop between a first terminal 40a and a second terminal 40b of an electrical connector 40 of the vehicle, linking these terminals to a source of electricity making it possible to establish a potential difference between them.

Advantageously, a self-regulating cable 30a, having a length and electrical characteristics that are determined, is placed between the free end of the first heating wire and a conventional conductive cable 41a, minimizing the resistive losses, linked to the first terminal 40a of the electrical circuit.

The self-regulating cable can be produced according to one of the variants described previously. For the example, reference is made hereinbelow to the description given in relation to FIG. 3. This cable 30a therefore comprises a first conductive wire 31 and a second conductive wire 32 separated by a carbon-enriched matrix. Here, at one end of the self-regulating cable 30a, the first conductive wire 31 is linked to the free end of the heating wire 25 and, at the other end of the self-regulating cable 30a, the second conductive wire 32 is linked to the conductive cable 41a.

The connections of the wires 31, 32 of the self-regulating cable 30a with the heating wire 25 and with the conductive cable 41a can be produced efficiently and economically by crimped connections 42a, 43a known to the person skilled in the art. There is no need, here, to make these connections removable.

Preferably, a similar setup is made with a second self-regulating cable 30b between the free end of the second heating wire 26 and the second terminal 40b of the electrical circuit.

As explained in the description of FIG. 1, the connection element 14 where the free ends of the heating wires 25, 26 exit is generally located under the hood, in proximity to the windscreen, but sheltered from the wind. The self-regulating cables are therefore located in a place where they are subjected to temperature conditions that change with the environmental conditions and that are generally higher than those encountered at the duct 15.

The self-regulating cables are therefore dimensioned in such a way that their resistivity changes to limit the current running through the wires 25, 26 of the heating element when the environmental conditions risk causing an overheating of the washing liquid transport and heating device in the tube 15. By contrast, when the temperature decreases and there is no risk of overheating, the self-regulating cable allows the nominal electrical power to pass, making it possible to ensure the heating of the liquid, in particular to ensure the defrosting of the duct 15.

In a variant, not represented, the conventional heating element 25, 26 is installed in the first part 18 of the liquid transport and heating device 10, before the connection device 14. The self-regulating cable(s) 30a, 30b can also have a part embedded in the liquid transport duct, downstream of the heating element 25, 26, so as to be in thermal contact with the liquid that has just been heated. In this case, the self-regulating cable(s) can be dimensioned to cut the electrical power supply of the heating element when it(they) is(are) subjected to a temperature approaching 100° C., so as to prevent the appearance of steam in the pipes.

The self-regulating cable(s) 30, 31, installed in series with a heating element according to the prior art, here ensure a thermostat function without introducing costly electronics.

In another variant, illustrated in FIG. 12, the self-regulating cable 30a, 30b can completely replace the normal conductive cable between the terminal 40a, 40b of the connector 40 and the free end of the corresponding heating wire 25, 26. This arrangement makes it possible in particular to use only one crimped connection 42a, 42b per self-regulating cable 30a, and thus minimize problems of bulk.

1. A device for transporting and heating a liquid that is installed between a liquid circulating means and a wiper of a wiping system, comprising:
a wall delimiting at least one liquid circulation duct and an electrical circuit configured to link two terminals set at different potentials and comprising a heating element embedded in said wall,
wherein at least one portion of said electrical circuit is formed by a self-regulating cable arranged to limit a current running in the electrical circuit as a function of a temperature rise.

2. The device according to claim 1, wherein said cable comprises at least two electrically conductive heating wires, brought to different electrical potentials, and linked to one another by a semiconductive matrix.

3. The device according to claim 2, wherein at least one of the conductive wires comprises at least one conductive strand helically wound around an insulating fibre.

4. The device according to claim 3, wherein the conductive wire comprises at least three juxtaposed strands, helically wound around said insulating fibre.

5. The device according to claim 3, wherein the pitch of the helix lies between 1 and 10 turns over a length of 5 cm.

6. The device according to claim 1, wherein the self-regulating cable is formed by two heating wires and a semiconductive matrix, the two wires extending in parallel to said duct and equidistant therefrom.

7. The device according to claim 6, further comprising two cylindrical liquid circulation ducts, symmetrical to one another relative to a plane, in which the self-regulating cable is positioned in said plane, said semiconductive matrix extending, in cross section, on either side of the line linking the centres of gravity of the sections of the two ducts.

8. The device according to claim 3, wherein the self-regulating cable is formed by two heating wires and a semiconductive matrix, the two wires being concentric and the matrix being positioned in the interval situated between the two wires.

9. The device according to claim 8, wherein the inner heating wire comprises said conductive strand helically wound around the insulating fibre.

10. The device according to claim 8, wherein the outer heating wire comprises at least one conductive strand helically wound around said semiconductive matrix.

11. The device according to claim 8, further comprising two cylindrical liquid circulation ducts, symmetrical to one another relative to a plane, in which the self-regulating cable constitutes the heating element and is positioned on the line linking the centres of gravity of the sections of the two ducts.

12. The device according to claim 3, wherein the self-regulating cable constitutes the heating element and is formed by two heating wires coated in a semiconductive matrix and each comprising a conductive strand helically wound around an insulating fibre, the two wires being twisted with one another.

13. The device according to claim 12, further comprising two cylindrical liquid circulation ducts, symmetrical to one another relative to a plane, in which the self-regulating cable is positioned on the line linking the centres of gravity of the sections of the two ducts.

14. The device according to claim 2, further comprising at least one self-regulating cable of which a first of said at least two conductive wires is linked to a terminal of said electrical circuit and a second of said at least two conductive wires is linked to an end of said heating element.

15. The device according to claim 13, in which at least a part of the self-regulating cable is also embedded in said wall, downstream of the heating element relative to the circulation of the liquid.

16. A pipeline for transporting windscreen washer liquid comprising a device for transporting and heating said liquid according to claim 1.

17. A system for supplying and/or dispensing windscreen washer liquid to be sprayed onto a window of a vehicle comprising at least one tank, a liquid circulating means, a means for spraying said liquid and a pipeline according to claim 16.
